(19) United States
(12) Patent Application Publication
(10) Pub. No.: US 2025/0306285 A1
(43) Pub. Date: Oct. 2, 2025

(54) PASSIVE LENS ARRAY STRUCTURE FOR PHOTONIC INTEGRATED CIRCUIT (PIC)

(71) Applicant: Intel Corporation, Santa Clara, CA (US)

(72) Inventors: Stephanie AROUH, Hillsboro, OR (US); Li YUAN, Fremont, CA (US); Fan FAN, Chandler, AZ (US); Srikant NEKKANTY, Chandler, AZ (US); Kumar Abhishek SINGH, Phoenix, AZ (US); Saikumar JAYARAMAN, Chandler, AZ (US)

(21) Appl. No.: 18/620,743

(22) Filed: Mar. 28, 2024

(51) Int. Cl. G02B 6/30

(52) U.S. Cl. CPC G02B 6/30

(57) ABSTRACT

An embodiment may include an apparatus comprising a substrate with a thickness between a first surface and a second surface, where the substrate comprises a glass layer and a hole into the first surface of the substrate and into the glass layer. In an embodiment, a depth of the hole is less than the thickness, and a lens is on the second surface of the substrate, where a first axial centerline of the hole is substantially coincident with a second axial centerline of the lens.

### BACKGROUND

Optical data links are potential candidates to address scalability challenges of electrical interconnects over long distances due to their potential for negligible frequency-dependent loss. Optical interconnects based on integrated photonics (e.g., silicon photonics) or discrete photonics (e.g., vertical cavity surface-emitting lasers (VCSELs), micro light emitting diodes (μLEDs), a photodiode (PD), etc.) are used in various applications. The optical signals from these devices are transmitted to optoelectronic dies through optical fibers or other interconnects.

However, a major drawback of many optical coupling systems is the need for precise alignment. Providing the alignment during assembly of an optical coupling system is resource intensive. In an active alignment process, fibers are aligned and the optical power across the optical coupling is measured. The alignment is adjusted until the signal strength reaches a suitable threshold. This process requires skilled manual intervention and can take a long time. When many optical connections are necessary for a large system (e.g., a server farm or other large network), the cost to make the necessary connections can be prohibitive.

### BRIEF DESCRIPTION OF THE DRAWINGS

FIG. 1A is a perspective view illustration of a micro lens array (MLA) with blind holes that are aligned with lenses in order to provide passive alignment of fibers, in accordance with an embodiment.

FIG. 1B is a cross-sectional illustration of the MLA of FIG. 1A along line B-B′, in accordance with an embodiment.

FIG. 1C is a cross-sectional illustration of the MLA of FIG. 1A through the length of the optical fibers, in accordance with an embodiment.

FIG. 1D is a cross-sectional illustration of an MLA with blind holes that include a taper for easier insertion of the fibers, in accordance with an embodiment.

FIG. 1E is a cross-sectional illustration of an MLA with lenses that are discrete components attached to the glass substrate, in accordance with an embodiment.

FIG. 2A is a cross-sectional illustration of an optical coupling system that comprises an MLA and a fiber protrusion array (FA) for handling an array of optical fibers, in accordance with an embodiment.

FIG. 2B is a cross-sectional illustration of the FA of FIG. 2A along line B-B′, in accordance with an embodiment.

FIG. 2C is a cross-sectional illustration of an FA with a flat top surface, in accordance with an embodiment.

FIG. 3A is a perspective view illustration of an MLA with a ledge for supporting the optical fibers outside of the holes, in accordance with an embodiment.

FIG. 3B is a cross-sectional illustration of the MLA of FIG. 3A that shows V-grooves in the ledge for improved alignment, in accordance with an embodiment.

FIG. 3C is a cross-sectional illustration of an MLA with a ledge that comprises a flat top surface, in accordance with an embodiment.

FIGS. 4A-4H are illustrations that depict a process for forming an MLA with laser direct writing (LDW), in accordance with an embodiment.

FIG. 5 is a process flow diagram depicting a process for forming an MLA with LDW, in accordance with an embodiment.

FIG. 6 is a cross-sectional illustration of an opto-electronic system that comprises an optical coupling system that is optically coupled to a photonic integrated circuit (PIC), in accordance with an embodiment.

FIG. 7 is a schematic of a computing device built in accordance with an embodiment.

### DETAILED DESCRIPTION

Described herein are electronic systems, and more particularly, passive lens arrays for photonic integrated circuits (PICs), in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

As noted above, optical data links are a promising technology to scale data transmission rates. However, the need for active alignment for optical coupling solutions is a significant expense to the assembly of optics based systems. Existing solutions may include a fiber array with a first end of the optical fibers coupled to a photonics integrated circuit (PIC) and the second end terminated with an MTP connector. However, in such solutions, the fiber array needs to be long (e.g., greater than 6.0 cm) in order to allow for handling during testing. This introduces mechanical stress to the attached fibers, which can lead to failures at the point of attach. Further, the attachment to the associated fiber array unit (FAU) is done with an active alignment process. This leads to increases in cost and throughput. Additionally, MTP connectors include polymeric components that have a relatively low melting temperature. As such, MTP connectors are not suitable for packages that will undergo solder reflow processes (e.g., above approximately 150° C.).

Accordingly, embodiments disclosed herein comprise optical coupling systems that include a micro lens array (MLA). The glass MLA allows for precise machining through the use of laser direct writing (LDW). For example, blind holes can be formed into a first surface of the glass substrate for receiving the optical fibers (e.g., glass fibers). As used herein “blind holes” may refer to holes that do not pass entirely through a substrate. That is, a blind hole has a single opening in some embodiments. Additionally, the surface of the glass substrate opposite from the hole openings may be patterned to form lenses. Each lens may be paired with one of the holes. LDW process provide precise patterning control that allows for an axial centerline of the hole to be substantially coincident with an axial centerline of the lens. As such, insertion of the optical fiber into the hole accomplishes a passive alignment process. This reduces costs and improves throughput of optical system assembly. In an embodiment, the lenses may be beam expanding lenses. Accordingly, the subsequent alignment to the ends of the optical fibers is simplified as well.

Embodiments disclosed herein may also benefit from high temperature compatibility. For example, the materials included in the optical coupling system may comprise glass and epoxy. Both material classes have high melting temperatures, which enables integration into packages that will undergo reflow. Particularly, embodiments are compatible with high reflow temperature solders, such as tin-silver-copper (SAC) solder, which may have a reflow temperature above approximately 260° C.

Embodiments disclosed herein may also improve mechanical support to the optical fibers in order to minimize damage to the optical fibers or connections to the optical fibers. For example, optical fibers may have a length that is approximately 50 mm or less, or approximately 20 mm or less. Further, the inclusion of a fiber protrusion array (FA) provides mechanical support to optical fibers (and optionally enhances alignment to the PIC through the inclusion of V-grooves). The FA may also be replaced with a ledge that extend out from the surface of the MLA in which the holes are formed.

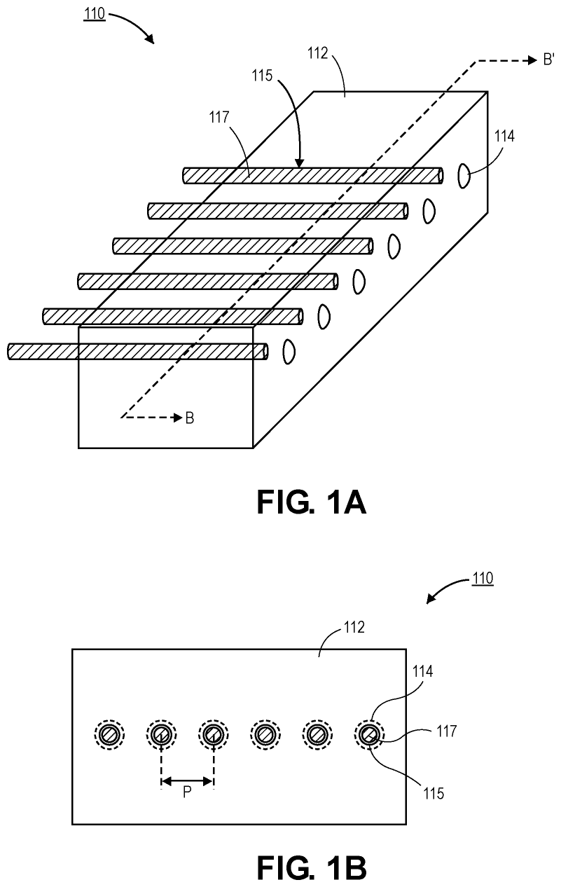

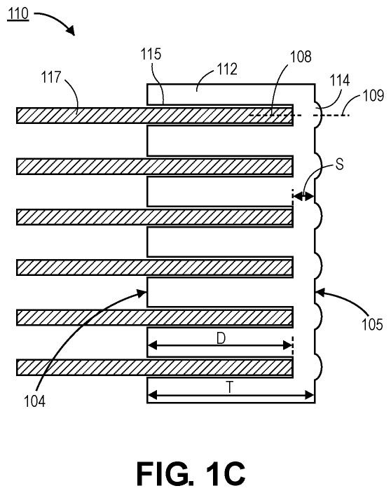

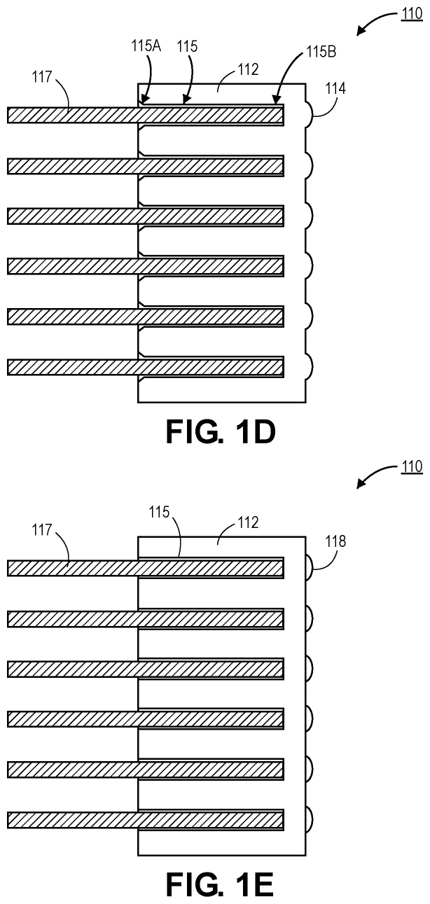

Referring now to FIG. 1A, a perspective view illustration of an MLA 110 is shown, in accordance with an embodiment. In an embodiment, the MLA 110 may comprise a substrate 112, such as a rectangular prism substrate. The substrate 112 may comprise glass. For example, the substrate 112 may be a block of glass such that the substrate 112 is entirely glass. The substrate 112 may be a glass material with an amorphous crystal structure where the solid glass substrate 112 may also include various structures (e.g., holes or lenses) as will be described in greater detail herein.

The glass substrate 112 may be any suitable glass formulation that has the necessary mechanical robustness and compatibility with semiconductor packaging manufacturing and assembly processes. For example, the glass substrate 112 may comprise aluminosilicate glass, borosilicate glass, alumino-borosilicate glass, silica, fused silica, or the like. In some embodiments, the glass substrate 112 may include one or more additives, such as, but not limited to, Al₂O₃, B₂O₃, MgO, CaO, SrO, BaO, SnO₂, Na₂O, K₂O, SrO, P₂O₃, ZrO₂, Li₂O, Ti, or Zn. More generally, the glass substrate 112 may comprise silicon and oxygen, as well as any one or more of aluminum, boron, magnesium, calcium, barium, tin, sodium, potassium, strontium, phosphorus, zirconium, lithium, titanium, or zinc. In an embodiment, the glass substrate 112 may comprise at least 23 percent silicon (by weight) and at least 26 percent oxygen (by weight). In some embodiments, the glass substrate 112 may further comprise at least 5 percent aluminum (by weight).

In an embodiment, a plurality of optical fibers 117 may be inserted into holes 115 that are formed into a surface of the glass substrate 112. The holes 115 may be blind holes since they do not pass entirely through a thickness of the glass substrate 112. For example, the holes 115 may extend to within 100 μm of the opposing surface of the glass substrate 112. In an embodiment, the optical fibers 117 may comprise glass fibers suitable for propagating optical signals. In the illustration of FIG. 1A, the holes 115 and the fibers 117 have a similar diameter so that there is substantially no gap between the fibers 117 and the holes 115. Though, in other embodiments, a small difference in diameter (with the hole 115 having a larger diameter) may allow for easier insertion of the fiber 117 into the hole 115.

In the illustrated embodiment, six fibers 117 are shown as an example illustration. However, it is to be appreciated that the MLA 110 may include any number of holes 115 for accommodating any number of fibers 117. For example, the MLA 110 may comprise up to twelve holes 115, up to twenty four holes 115, or more than twenty four holes 115.

In an embodiment, the MLA 110 may comprise a plurality of lenses 114 along a surface of the glass substrate 112. The lenses 114 may be fabricated as part of the glass substrate 112. That is, there is no interface between the lenses 114 and the glass substrate 112 in some embodiments. As will be described in greater detail below, the lenses 114 may be formed with an LDW process. In an embodiment, the lenses 114 may include beam expanding lenses 114. The use of beam expanding lenses 114 allows for improved optical coupling between components while reducing the alignment requirements. For example, the lenses expand the optical beam, which makes the alignment tolerances looser. Additionally, the lenses 114 may also collimate the optical signals to help further loosen the alignment tolerances.

The lenses 114 may be arranged in a line with each lens 114 being paired with one of the holes 115. Accordingly, an optical signal along the fiber 117 will exit the fiber 117, pass through a portion of the glass substrate 112, and exit the glass substrate 112 out the lens 114. In this way, the optical signal makes the transition from fiber 117 to lens 114 without having to pass an air-gap. This improves transmission properties and allows for stronger signals overall because the refractive index of the glasses match, whereas glass-to-air interfaces have a refractive index mismatch. The mismatch leads to higher reflections than in the glass-to-glass interface disclosed herein.

Referring now to FIG. 1B, a cross-sectional illustration of the MLA 110 in FIG. 1A along line B-B′ is shown, in accordance with an embodiment. In the illustrated cross-section, the relationships between the various components within the glass substrate 112 are shown. For example, each hole 115 and lens 114 may be substantially concentric circles with each other. The ability for the holes 115 and the lenses 114 to be aligned with a high degree of precision is provided by a LDW process, as will be described in greater detail herein. The lenses 114 are illustrated with dashed lines to indicate that the lenses 114 are on the opposite surface of the glass substrate 112.

In an embodiment, the fibers 117 that are inserted into the holes 115 are shown as having a smaller diameter than the holes 115. In an embodiment, the diameters of the fibers 117 and the holes may be within 95% of each other or within 99% of each other. That is, freedom of motion of a fiber 117 within a hole 115 is limited. Additionally, any displacement of the fiber 117 may be corrected by the lens 114. As such, passive alignment between the fiber 117 and the lens 114 is still maintained. In an embodiment, the fibers 117 may have a standard glass fiber diameter. For example, the fibers 117 may have a diameter that is approximately 125 μm. Though, any suitable diameter for the fibers 117 may be used in accordance with various embodiments. A pitch P of the fibers 117 may be up to approximately 250 μm or up to approximately 500 μm. Though, any suitable pitch P may be used in accordance with various embodiments described herein.

Referring now to FIG. 1C, a cross-sectional illustration of the MLA 110 showing a length of the fibers 117 is shown, in accordance with an embodiment. As shown, the fibers 117 may be inserted into the holes 115 so that the fibers 117 contact the bottom (or end) surface of the hole 115. In an embodiment, the glass substrate 112 may have a thickness T, and the holes 115 may have a depth D that is less than the thickness T of the glass substrate 112. The thickness T may be measured from a first surface 104 (where openings of the holes 115 are formed) to a second surface 105 (where the lenses 114 are formed). In an embodiment, the lenses 114 may be considered as protruding out from the glass substrate 112 and may not be considered as contributing to the thickness T of the glass substrate 112.

In an embodiment, a difference between the depth D of the holes 115 and the thickness T of the glass substrate 112 may be a spacing S. In an embodiment, the spacing S may be approximately 100 μm or less, approximately 50 μm or less, approximately 15 μm or less, or approximately 5 μm or less. Such fine precision is enabled through the use of the LDW process. In an embodiment, the depth D may be at least 80% of the thickness T, the depth D may be at least 95% of the thickness T, or the depth D may be at least 99% of the thickness T.

In an embodiment, the holes 115 may have axial centerlines 108, and the lenses 114 may have axial centerlines 109. In an embodiment, the axial centerlines 108 of the holes 115 may be substantially coincident with the axial centerlines 109 of the lenses 114. As used herein, “substantially coincident” may refer to two or more lines that are within approximately 5 μm (in any direction) of being perfectly coincident. Additionally, substantially coincident lines may have slopes that are within 5° of being perfectly parallel with each other.

Referring now to FIG. 1D, a cross-sectional illustration of an MLA 110 is shown, in accordance with an additional embodiment. In an embodiment, the MLA 110 in FIG. 1D may be similar to the MLA 110 in FIG. 1C, with the exception of the shape of the holes 115. Instead of having a substantially constant diameter through an entire depth of the hole 115 (as shown in FIG. 1C), the holes 115 in FIG. 1D include an opening 115A and a bottom 115B that have different diameters. The use of an opening 115A with a larger diameter can make inserting the fiber 117 into the hole 115 easier, and/or reduce mechanical stress points at the edge of the MLA 110. Further the larger opening 115A may have a tapered diameter that reduces to the final diameter of the bottom 115B of the hole 115. The taper may occupy a relatively short length of the hole 115 in some instances (e.g., up to approximately 10 μm, up to approximately 25 μm, or up to approximately 50 μm).

Referring now to FIG. 1E, a cross-sectional illustration of an MLA 110 is shown, in accordance with another embodiment. The MLA 110 in FIG. 1E may be similar to the MLA 110 in FIG. 1C, with the exception of the structure of the lenses 118. Instead of the lenses 114 being a monolithic structure with the glass substrate 112, FIG. 1E includes lenses 118 that are discrete components that are coupled to the glass substrate 112. In some instances, the lenses 118 may be adhered to the surface of the glass substrate 112 with an optical adhesive or the like.

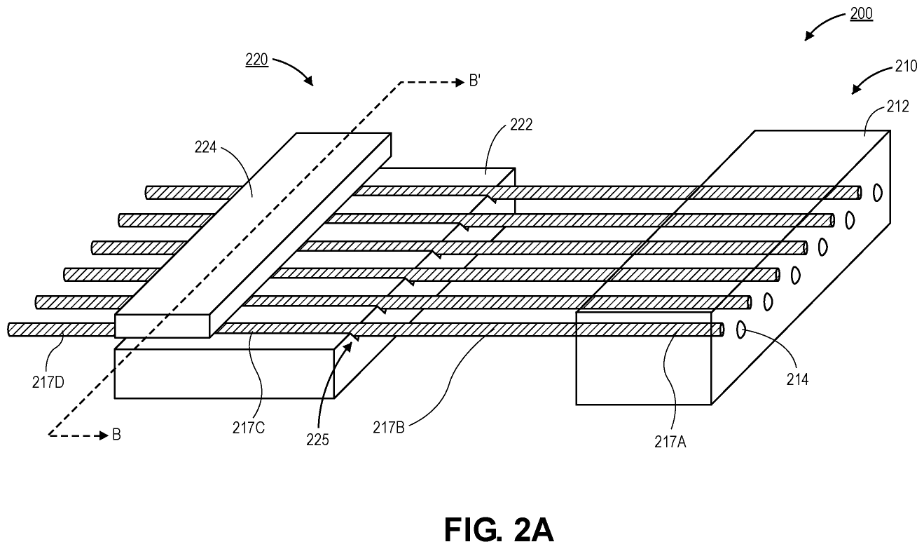

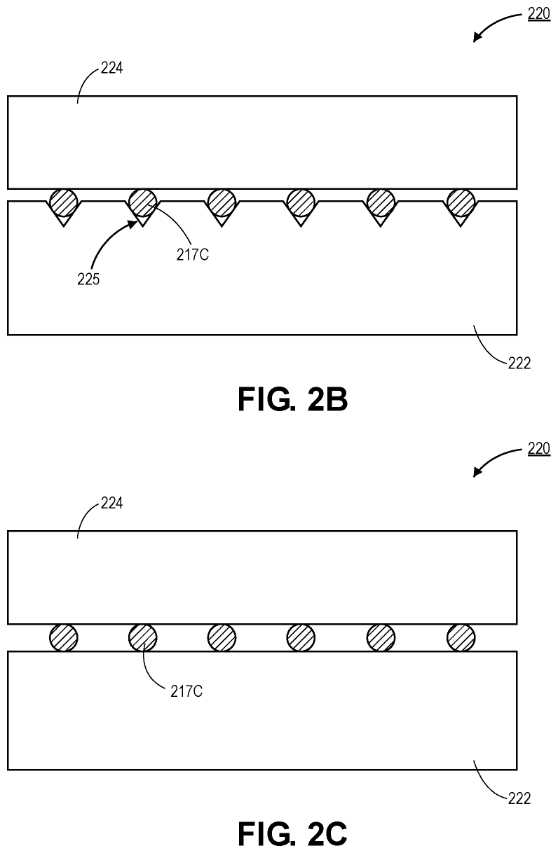

Referring now to FIG. 2A, a perspective view illustration of an optical coupling system 200 is shown, in accordance with an embodiment. In an embodiment, the optical coupling system 200 may comprise an MLA 210 and an FA 220. The MLA 210 provides the alignment of the fibers 217 to the lenses 214, while the FA 220 provides mechanical support to the fibers 217 while also providing alignment to a PIC (not shown).

In an embodiment, the MLA 210 may comprise a glass substrate 212 with fibers 217 inserted into holes (not visible in FIG. 2A) and lenses 214. The fiber portions 217A may be provided within the glass substrate 212, and the fiber portions 217A may be aligned with the lenses 214. The MLA 210 may be similar to any of the MLA structures described in greater detail herein.

In an embodiment, the FA 220 may comprise a base substrate 222. The base substrate 222 may comprise a glass material, such as any of the glass materials described in greater detail herein. In an embodiment, the base substrate 222 may comprise V-grooves 225 or any other suitable alignment structure in order to align the fiber 217 for connection to the PIC (not shown). For example, fiber portions 217C may be set into the V-grooves 225 of the base substrate 222, and fiber portions 217D may extend out towards the PIC. Fiber portions 217B may span across a gap between the MLA 210 and the FA 220.

In an embodiment, the FA 220 may further comprise a lid 224. The lid 224 may press down on the fiber portions 217C in order to secure the fiber portions 217C within the V-grooves 225 of the base substrate 222. In an embodiment, the lid 224 is a glass substrate that includes substantially flat surfaces. The fiber portions 217C may be secured between the base substrate 222 and the lid 224 with an epoxy or the like. Similar to the construction of the MLA 210, all of the components of the FA 220 are high temperature materials. Accordingly, the entire optical coupling system 200 is compatible with reflow processes, and the optical coupling system 200 may be integrated on a single board or package that undergoes reflow.

Referring now to FIG. 2B, a cross-sectional illustration of the FA 220 in FIG. 2A along line B-B′ is shown, in accordance with an embodiment. In an embodiment, the FA 220 includes the base substrate 222 with an overlying lid 224. The V-grooves 225 within the base substrate 222 may provide locations for supporting the fiber portions 217C. Since the fiber portions 217C are set into the V-grooves 225, the bottom surface of the fiber portions 217C may be at a lower Z-position than a top of the base substrate 222. Further, the lid 224 is shown as having a substantially flat surface.

Referring now to FIG. 2C, a cross-sectional illustration of an alternative FA 220 solution is shown, in accordance with an embodiment. As shown, the FA 220 may include a base substrate 222 that also has a substantially flat surface for supporting the fiber portions 217C. Such embodiments may be suitable for when the alignment of the optical fibers to the PIC is accomplished at a different location along the optical coupling system 200.

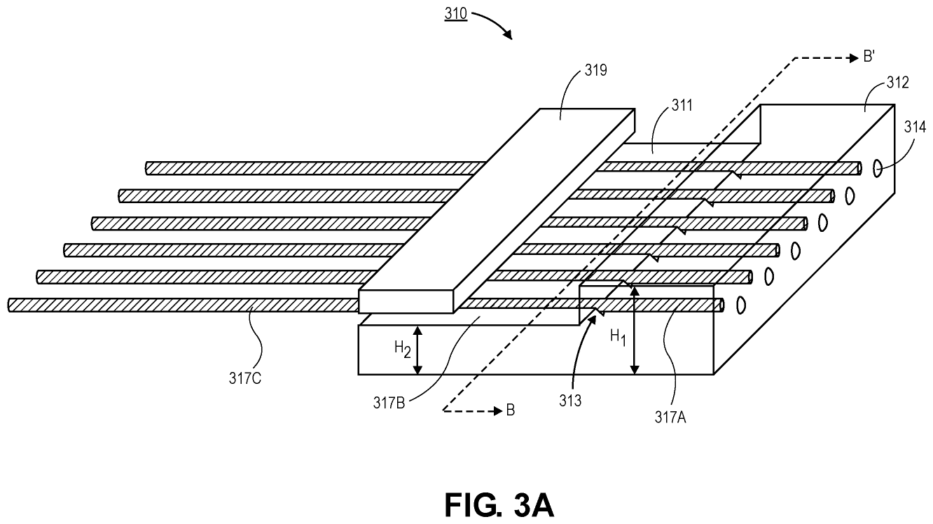

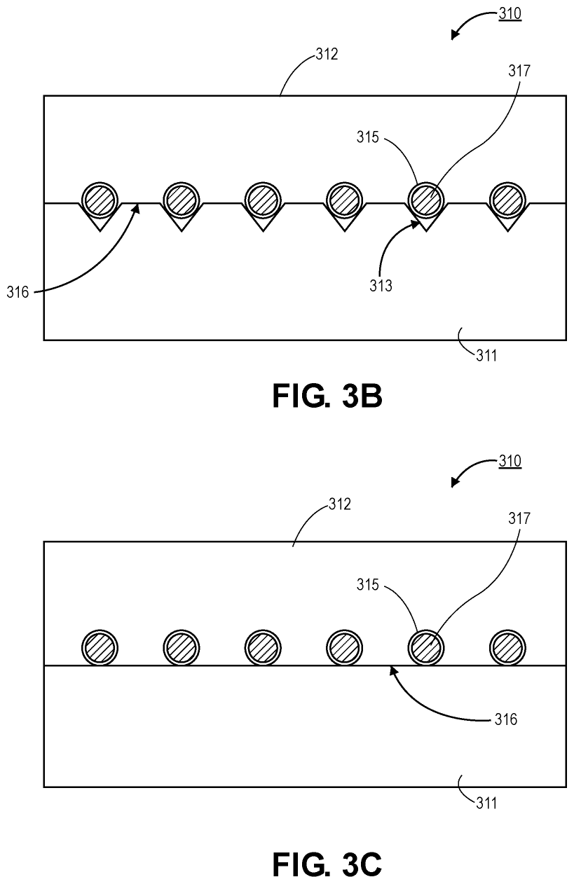

Referring now to FIG. 3A, a perspective view illustration of an alternative MLA 310 is shown, in accordance with an embodiment. The MLA 310 may comprise a glass substrate 312 that is similar to any of the glass substrates described in greater detail herein. In an embodiment, blind holes for accommodating fiber portions 317A are provided in the glass substrate 312. The holes and the fiber portions 317A may be aligned with lenses 314. In some instances, the portion of the MLA 310 within the glass substrate 312 may be similar to any of the MLA architectures described in greater detail herein.

In an embodiment, the MLA 310 may further comprise a ledge 311. The ledge 311 may extend out from a surface of the glass substrate 312 on which the holes are formed. The ledge 311 may also comprise glass. For example, the glass substrate 312 and the ledge 311 may be a monolithic structure in some embodiments. In an embodiment, the ledge 311 may have a height that is suitable for supporting fiber portions 317B. For example, the glass substrate 312 may have a first height H₁, and the ledge 311 may have a second height H₂ that is smaller than the first height H₁. The presence of the ledge 311 provides improved mechanical support for the fiber portions 317B. In some embodiments, the ledge 311 may also comprise V-grooves 313 for helping to align the fiber portions 317B. The MLA 310 may also comprise a lid 319 for securing the fiber portions 317B against the ledge 311. The lid 319 may also be a glass material. An epoxy or the like may help secure the lid 319 to the fiber portions 317B and the ledge 311. Fiber portions 317C may extend out towards the PIC (not shown).

Referring now to FIG. 3B, a side view of the MLA 310 in FIG. 3A looking towards a section along line B-B′ is shown, in accordance with an embodiment. As shown, the ledge 311 comprises V-grooves 313, and the fibers 317 are set into the V-grooves before entering the holes 315 into the glass substrate 312. That is, in order to account for the depth of the V-grooves 313, the top surface 316 of the ledge 311 may be at a Z-position that intersects the holes 315. In an embodiment, the V-groove 313 has a centerline that is substantially within the same plane as axial centerlines of one or both of the hole 315 or the lens 314.

Referring now to FIG. 3C, a side view of an MLA 310 along a plane similar to what is depicted in FIG. 3B is shown, in accordance with an embodiment. In an embodiment, the MLA 310 in FIG. 3C is similar to the MLA 310 in FIG. 3B, with the exception of the top surface 316 of the ledge 311. Instead of including V-grooves 313, the top surface 316 in FIG. 3C is substantially flat.

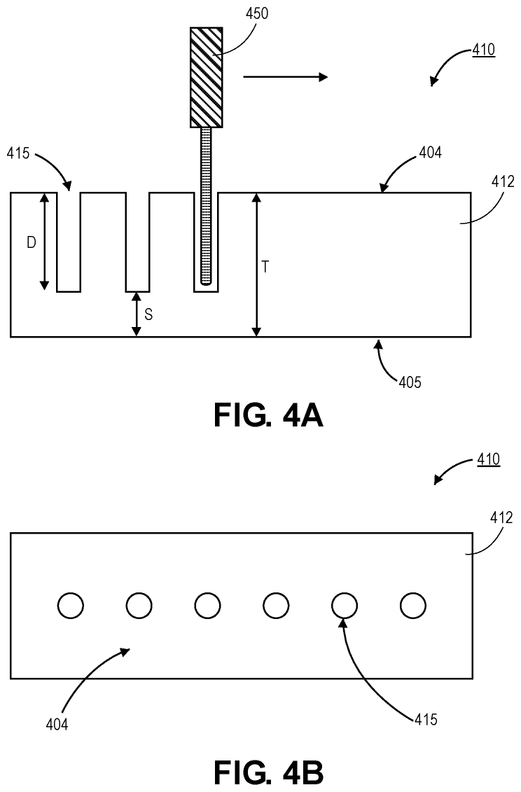

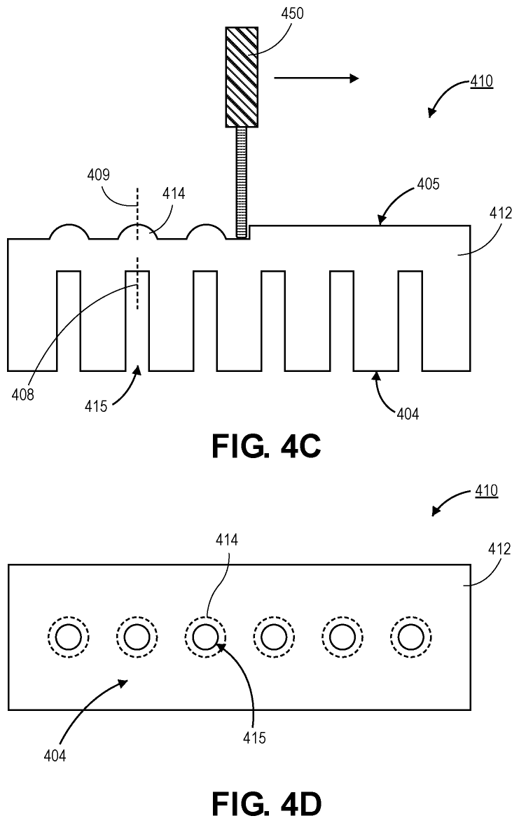

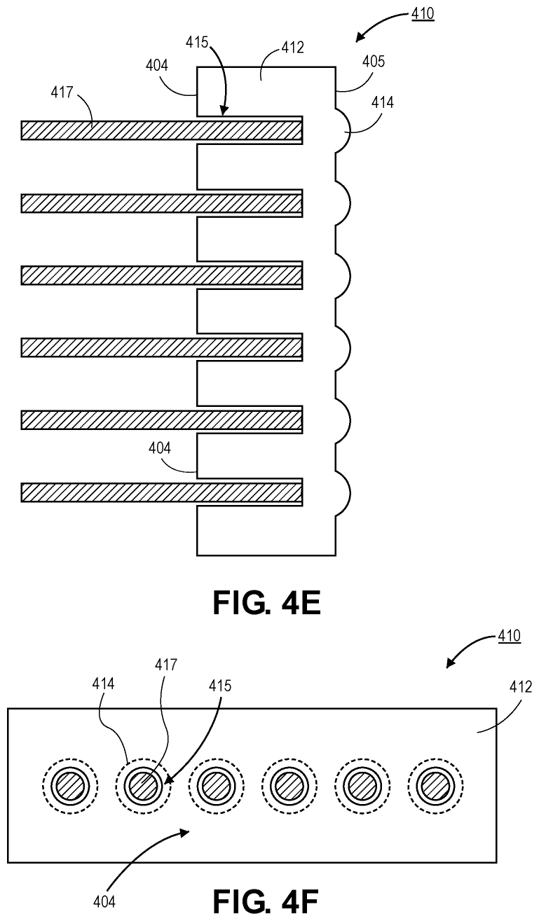

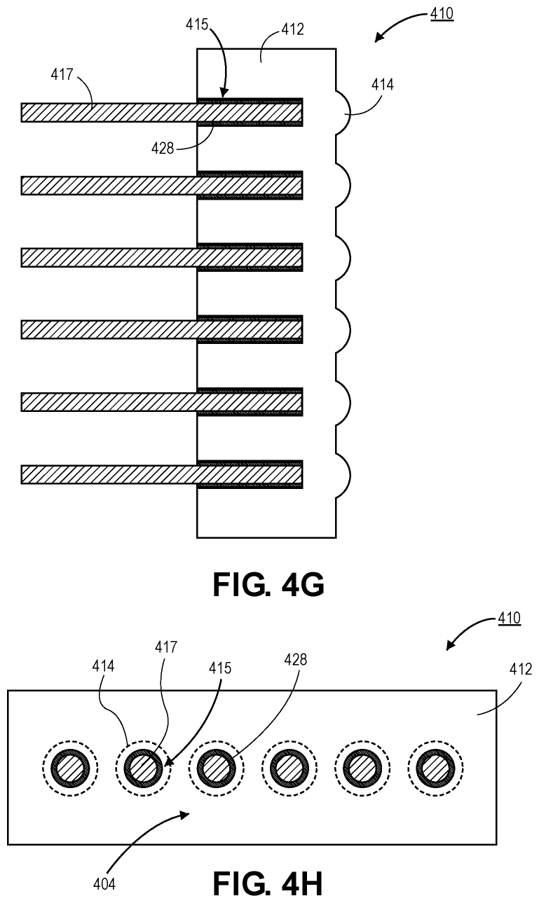

Referring now to FIGS. 4A-4H, a series of illustrations depicting a process for forming an MLA 410 is shown, in accordance with an embodiment. In an embodiment, the MLA 410 is fabricated from a single block of glass using LDW processes. The use of LDW processes enables precise control of hole depths, alignment, lens shape, and/or the like.

Referring now to FIG. 4A, a cross-sectional illustration of an MLA 410 at a stage of manufacture is shown, in accordance with an embodiment. The MLA 410 may comprise a glass substrate 412. The glass substrate 412 may be similar to any of the glass substrates described in greater detail herein. In an embodiment, the glass substrate 412 may have a thickness T between a first surface 404 and a second surface 405.

In an embodiment, a LDW process is used in order to form one or more blind holes 415 into the first surface 404 of the glass substrate 412. For example, a laser 450 ablates portions of the glass substrate 412 as the laser 450 moves across the surface 404 of the glass substrate 412 (as indicated by the arrow). For example, the first three holes 415 have been formed in FIG. 4A. In an embodiment, the holes 415 may have a depth D that is less than the thickness T. In an embodiment, a difference between the thickness T and the depth D may be a spacing S between a bottom of the hole 415 and the second surface 405. In an embodiment, the spacing S may be approximately 100 μm or less, approximately 50 μm or less, approximately 15 μm or less, or approximately 5 μm or less. Such fine precision is enabled through the use of the LDW process. In an embodiment, the depth D may be at least 80% of the thickness T, the depth D may be at least 95% of the thickness T, or the depth D may be at least 99% of the thickness T.

Referring now to FIG. 4B, a plan view illustration of the portion of the MLA 410 at a stage of manufacture is shown, in accordance with an embodiment. FIG. 4B illustrates the first surface 404 of the glass substrate 412. As shown, a plurality of holes 415 are formed with openings at the first surface 404. In an embodiment, the holes 415 may be arranged in a line. Though, other patterns may also be used in some embodiments. The holes 415 may have a constant pitch as well.

Referring now to FIG. 4C, a cross-sectional illustration of the portion of the MLA 410 at a subsequent stage of manufacturing is shown, in accordance with an embodiment. In an embodiment, the MLA 410 may have been flipped over so that the second surface 405 is facing up. In an embodiment, an additional LDW process is implemented on the second surface 405 in order to form a plurality of lenses 414. In an embodiment, the lenses 414 may be formed with a subtractive process that results in the second surface 405 being recessed below the top of the lenses 414. In an embodiment, the lenses 414 are each aligned with one of the holes 415. The LDW process allows for precise alignment. Therefore, an axial centerline 408 of the hole 415 may be substantially coincident with an axial centerline 409 of the lens. This allows for simple passive alignment of the optical fiber (not shown) to the lens.

Referring now to FIG. 4D, a plan view illustration of the first surface 404 of the MLA 410 after the lenses 414 are all formed is shown, in accordance with an embodiment. As shown, the lenses 414 and the holes 415 are substantially concentric with each other. The lenses 414 may have diameters that are bigger than the diameters of the holes 415 in some embodiments.

Referring now to FIG. 4E, a cross-sectional illustration of the MLA 410 at a subsequent stage of manufacture is shown, in accordance with an embodiment. The cross-section in FIG. 4E is along a plane through the holes 415 and the lenses 414. In an embodiment, optical fibers 417 (e.g., glass fibers 417) have been inserted into the holes 415. In an embodiment, the fibers 417 may be inserted into the holes 415 with any suitable process. In an embodiment, the optical fibers 417 are inserted into the holes 415 so that ends of the fibers 417 contact a bottom surface of the holes 415. Since the holes 415 are substantially aligned with the lenses 414, the inserted fibers 417 will also be substantially aligned with the lenses using a completely passive approach. This allows for cost and time savings during the assembly of an optical system. Referring now to FIG. 4F, a side view of the MLA 410 looking at the first surface 404 is shown, in accordance with an embodiment. In an embodiment, the side view depicts each set of a lens 414, a hole 415, and a fiber 417 are substantially concentric with each other.

Referring now to FIG. 4G, a cross-sectional illustration of the MLA 410 at a subsequent stage of manufacture is shown, in accordance with an embodiment. The cross-section in FIG. 4G is along a plane through the holes 415 and the lenses 414. As shown, an epoxy 428 is provided around the fibers 417 in order to secure the fibers 417 in the holes 415. In the illustrated embodiment, the epoxy 428 fills a remaining portion of the holes 415. In a more ideal situation, the holes 415 and the fibers 417 have substantially the same diameter (with the fiber 417 diameter be just slightly smaller than the hole 415 diameter). In such an embodiment, the epoxy 428 may not have room to fill a significant portion of the hole 415. Instead, the epoxy 428 may seal the openings of the holes 415. The epoxy 428 may prevent pullout of the fibers 417 in some embodiments. FIG. 4H shows a side view of the MLA 410 looking at the first surface 404. As shown, the epoxy 428 may surround the fibers 417 in order to lock the fibers 417 in place within the holes 415.

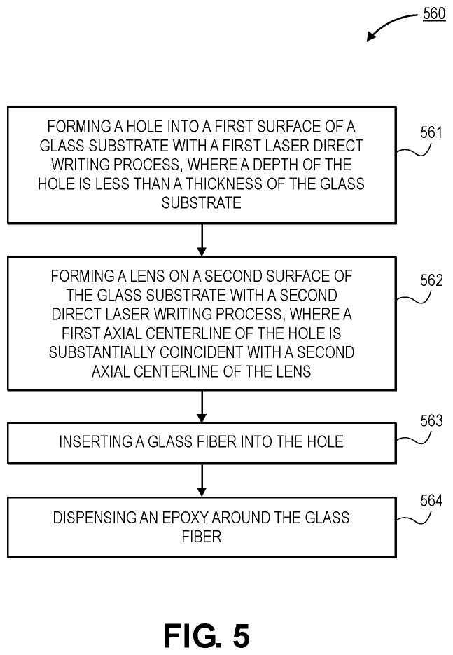

Referring now to FIG. 5, a process flow diagram of a process 560 for fabricating an MLA is shown, in accordance with an embodiment. In an embodiment, the MLA may be similar to any of the MLA structures described in greater detail herein. Similarly, the process 560 may be modified with any process operations or procedures described in greater detail herein (e.g., any of the operations described with respect to FIGS. 4A-4H).

In an embodiment, the process 560 may begin with operation 561, which comprises forming a hole into a first surface of a glass substrate with a first LDW process. In an embodiment, a depth of the hole is less than a thickness of the glass substrate. In an embodiment, a difference between the thickness of the glass substrate and a depth of the hole may be approximately 100 μm or less, approximately 50 μm or less, approximately 15 μm or less, or approximately 5 μm or less. Such fine precision is enabled through the use of the LDW process. In an embodiment, the depth may be at least 80% of the thickness, the depth may be at least 95% of the thickness, or the depth may be at least 99% of the thickness.

In an embodiment, the process 560 may continue with operation 562, which comprises forming a lens on a second surface of the glass substrate with a second LDW process. In an embodiment, a first axial centerline of the hole is substantially coincident with a second axial centerline of the lens. In an embodiment, the lens may be a beam expanding lens that can collimate light from a fiber that is inserted into the hole.

In an embodiment, the process 560 may continue with operation 563, which comprises inserting a glass fiber into the hole. In an embodiment, the glass fiber may be an optical fiber for optical communications. In an embodiment, the glass fiber may be inserted into the hole so that an end of the glass fiber directly contacts the bottom of the hole. In an embodiment, a diameter of the hole is just slightly larger than a diameter of the glass fiber. For example, the hole may have a diameter that is up to 5 μm larger than a diameter of the glass fiber. In an embodiment, the diameter of the hole may be up to 1 μm larger than a diameter of the glass fiber. Accordingly, insertion of the glass fiber into the hole provides near perfect optical alignment between the optical fiber and the lens. That is, passive coupling processes are enabled.

In an embodiment, the process 560 may continue with operation 564, which comprises dispensing an epoxy around the glass fiber. In an embodiment, the epoxy may surround the glass fiber at the first surface outside of the hole. Other embodiments may include at least some of the epoxy flowing into the hole adjacent to the glass fiber. In an embodiment, the epoxy can secure the glass fiber within the hole in order to prevent fiber pull-out during handling and/or operation.

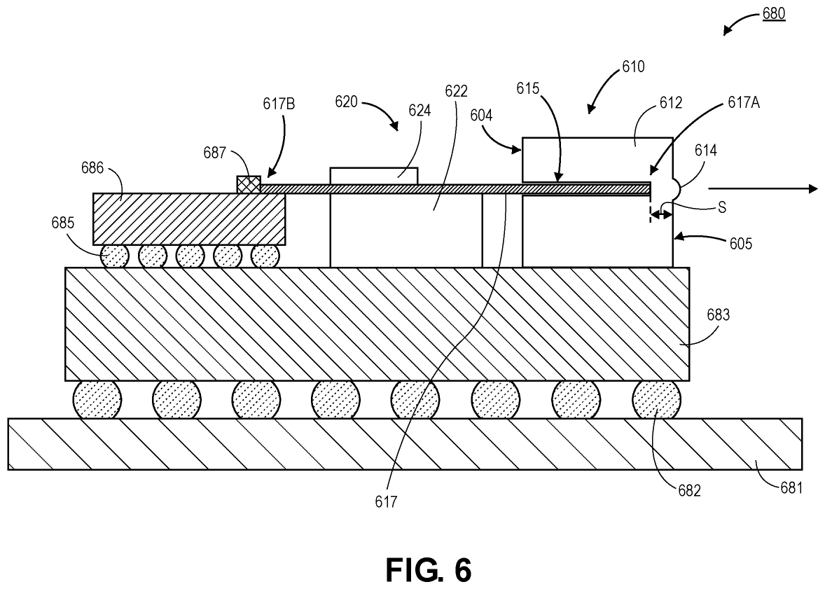

Referring now to FIG. 6, a cross-sectional illustration of an electronic system 680 is shown, in accordance with an embodiment. The electronic system 680 may comprise a board 681, such as a printed circuit board (PCB), a motherboard, or the like. The board 681 may be coupled to a package substrate 683 through second level interconnects (SLIs) 682. The SLIs 682 may comprise solder joints, pins, sockets, or the like.

In an embodiment, an optical coupling system comprising an MLA 610 and an FA 620 may be provided on the package substrate 683. The MLA 610 and the FA 620 may also be placed on the board 681 in some embodiments. In an embodiment, the MLA 610 and the FA 620 may be similar to any of the MLAs or FAs described in greater detail herein. For example, the MLA 610 may comprise a glass substrate 612 with a blind hole 615 into a first surface 604 of the glass substrate 612. The end of the hole 615 may be spaced apart from a second surface 605 of the glass substrate 612 by a spacing S that may be approximately 100 μm or less. In an embodiment, a lens 614 (e.g., a beam expanding lens) may be aligned axially with the hole 615.

The FA 620 may comprise a base substrate 622 (with or without V-grooves) and a lid 624 over the base substrate 622. In an embodiment, a glass fiber 617 may pass through the FA 620 and be inserted into the hole 615 of the MLA 610. In an embodiment, a first end 617A of the glass fiber 617 contacts an end of the hole 615, and a second end 617B of the glass fiber 617 is optically coupled to a PIC 686 by an optical coupler 687. In an embodiment, the PIC 686 may be coupled to the package substrate 683 by any suitable first level interconnect (FLI) 685 architecture. For example, FLIs 685 may comprise solder bumps, copper bumps, hybrid bonding, and/or the like. In an embodiment, the PIC 686 may convert optical signals to electrical signals and vice-versa. The PIC 686 may be communicatively coupled to a die (not shown) that is configured to process data delivered along the optical interconnects. The die may be any type of die, such as a central processing unit (CPU), a graphics processing unit (GPU), an XPU, a communications die, a memory die, or the like.

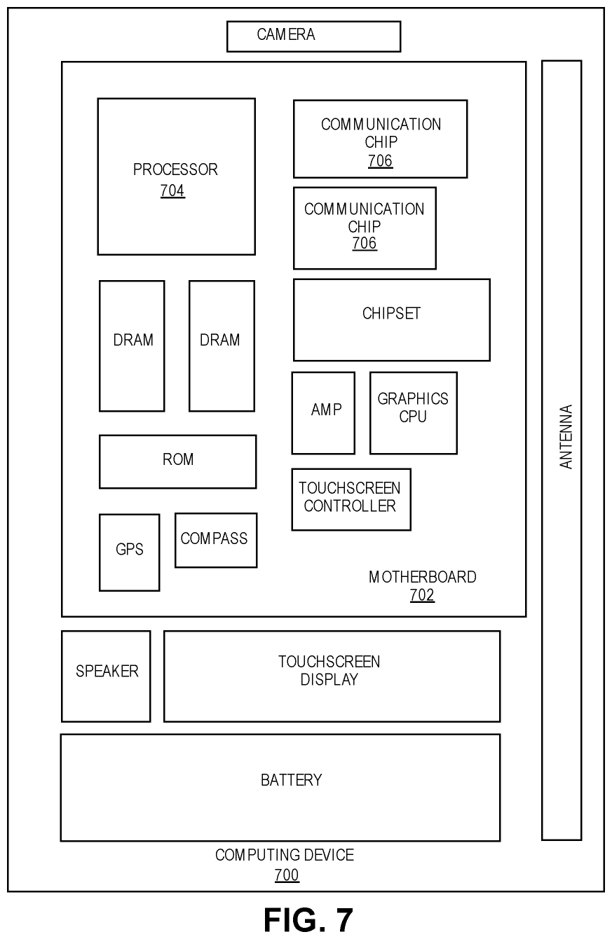

FIG. 7 illustrates a computing device 700 in accordance with one implementation of the disclosure. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

The processor 704 of the computing device 700 includes an integrated circuit die packaged within the processor 704. In some implementations of the disclosure, the integrated circuit die of the processor may be part of an optical package that includes an MLA with a glass substrate that includes a blind hole that is axially aligned with a beam expanding lens, in accordance with embodiments described herein. The term “processor” may refer to any device or portion of a device that processes electronic data from registers and/or memory to transform that electronic data into other electronic data that may be stored in registers and/or memory.

The communication chip 706 also includes an integrated circuit die packaged within the communication chip 706. In accordance with another implementation of the disclosure, the integrated circuit die of the communication chip may be part of an optical package that includes an MLA with a glass substrate that includes a blind hole that is axially aligned with a beam expanding lens, in accordance with embodiments described herein.

In an embodiment, the computing device 700 may be part of any apparatus. For example, the computing device may be part of a personal computer, a server, a mobile device, a tablet, an automobile, or the like. That is, the computing device 700 is not limited to being used for any particular type of system, and the computing device 700 may be included in any apparatus that may benefit from computing functionality.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus comprising: a substrate with a thickness between a first surface and a second surface, wherein the substrate comprises a glass layer; a hole into the first surface of the substrate and into the glass layer, wherein a depth of the hole is less than the thickness; and a lens on the second surface of the substrate, wherein a first axial centerline of the hole is substantially coincident with a second axial centerline of the lens.

Example 2: the apparatus of Example 1, wherein the thickness of the substrate is up to 100 μm greater than the depth of the hole.

Example 3: the apparatus of Example 1 or Example 2, wherein the first axial centerline is within 5 μm of being perfectly coincident with the second axial centerline.

Example 4: the apparatus of Examples 1-3, wherein the lens is a beam expander.

Example 5: the apparatus of Examples 1-4, wherein the lens and the substrate are a monolithic structure.

Example 6: the apparatus of Examples 1-5, wherein the lens is a coupled to the substrate by an adhesive.

Example 7: the apparatus of Examples 1-6, wherein the hole has a substantially constant diameter through an entire depth of the hole.

Example 8: the apparatus of Examples 1-7, wherein the hole has a first diameter at the first surface and a second diameter at an end of the hole, wherein the first diameter is greater than the second diameter.

Example 9: the apparatus of Examples 1-8, further comprising: a ledge protruding from the first surface of the substrate; and a V-groove in the ledge, wherein the V-groove has a centerline that is substantially within a same plane as the first axial centerline or the second axial centerline.

Example 10: the apparatus of Examples 1-9, further comprising: a glass fiber within the hole.

Example 11: an apparatus, comprising: a substrate, wherein the substrate comprises a glass block; a plurality of holes into the substrate that pass into the glass block, wherein the plurality of holes are arranged in a line across a first surface of the substrate, and wherein the plurality of holes are blind holes that pass partially through a thickness of the substrate; and a plurality of lenses across a second surface of the substrate, wherein individual ones of the plurality of lenses are aligned with a different one of the plurality of holes.

Example 12: the apparatus of Example 11, wherein each of the plurality of holes have an end that is up to approximately 100 μm away from the second surface of the substrate.

Example 13: the apparatus of Example 11 or Example 12, wherein the plurality of holes comprises up to twenty four holes, and wherein the plurality of lenses comprises up to twenty four lenses.

Example 14: the apparatus of Examples 11-13, wherein the plurality of holes are spaced at a pitch that is up to 500 μm.

Example 15: the apparatus of Examples 11-14, wherein each of the plurality of lenses has a first axial centerline that is within 5 μm of being coincident with a second axial centerline of different ones of the plurality of holes.

Example 16: the apparatus of Examples 11-15, wherein each of the plurality of lenses has a first diameter, and each of the plurality of holes has a second diameter, and wherein the first diameter is greater than the second diameter.

Example 17: an apparatus, comprising: a micro lens array (MLA), wherein the MLA comprises: a first glass substrate; a hole into a first surface of the first glass substrate, wherein the hole has an end that is up to 100 μm away from a second surface of the first glass substrate; and a lens on the second surface of the glass substrate, wherein the lens is a beam expander, and wherein the lens is aligned with the hole; a fiber protrusion array (FA), wherein the FA comprises: a second glass substrate; and a V-groove into a surface of the second glass substrate; and a glass fiber with a first end and a second end, wherein the first end of the glass fiber is in the hole, and wherein a middle portion of the glass fiber between the first end and the second end is in the V-groove.

Example 18: the apparatus of Example 17, further comprising: a glass block over the middle portion of the glass fiber.

Example 19: the apparatus of Example 17 or Example 18, wherein the second end of the glass fiber is optically coupled to a photonic integrated circuit (PIC).

Example 20: the apparatus of Example 19, further comprising: a board, wherein the MLA, the FA, and the PIC are provided on the board.

What is claimed is:

1. An apparatus comprising:
a substrate with a thickness between a first surface and a second surface, wherein the substrate comprises a glass layer;
a hole into the first surface of the substrate and into the glass layer, wherein a depth of the hole is less than the thickness; and
a lens on the second surface of the substrate, wherein a first axial centerline of the hole is substantially coincident with a second axial centerline of the lens.

2. The apparatus of claim 1, wherein the thickness of the substrate is up to 100 μm greater than the depth of the hole.

3. The apparatus of claim 1, wherein the first axial centerline is within 5 μm of being perfectly coincident with the second axial centerline.

4. The apparatus of claim 1, wherein the lens is a beam expander.

5. The apparatus of claim 1, wherein the lens and the substrate are a monolithic structure.

6. The apparatus of claim 1, wherein the lens is a coupled to the substrate by an adhesive.

7. The apparatus of claim 1, wherein the hole has a substantially constant diameter through an entire depth of the hole.

8. The apparatus of claim 1, wherein the hole has a first diameter at the first surface and a second diameter at an end of the hole, wherein the first diameter is greater than the second diameter.

9. The apparatus of claim 1, further comprising:
a ledge protruding from the first surface of the substrate; and
a V-groove in the ledge, wherein the V-groove has a centerline that is substantially within a same plane as the first axial centerline or the second axial centerline.

10. The apparatus of claim 1, further comprising:
a glass fiber within the hole.

11. An apparatus, comprising:
a substrate, wherein the substrate comprises a glass block;
a plurality of holes into the substrate that pass into the glass block, wherein the plurality of holes are arranged in a line across a first surface of the substrate, and wherein the plurality of holes are blind holes that pass partially through a thickness of the substrate; and
a plurality of lenses across a second surface of the substrate, wherein individual ones of the plurality of lenses are aligned with a different one of the plurality of holes.

12. The apparatus of claim 11, wherein each of the plurality of holes have an end that is up to approximately 100 μm away from the second surface of the substrate.

13. The apparatus of claim 11, wherein the plurality of holes comprises up to twenty four holes, and wherein the plurality of lenses comprises up to twenty four lenses.

14. The apparatus of claim 11, wherein the plurality of holes are spaced at a pitch that is up to 500 μm.

15. The apparatus of claim 11, wherein each of the plurality of lenses has a first axial centerline that is within 5 μm of being coincident with a second axial centerline of different ones of the plurality of holes.

16. The apparatus of claim 11, wherein each of the plurality of lenses has a first diameter, and each of the plurality of holes has a second diameter, and wherein the first diameter is greater than the second diameter.

17. An apparatus, comprising:
a micro lens array (MLA), wherein the MLA comprises:
a first glass substrate;
a hole into a first surface of the first glass substrate, wherein the hole has an end that is up to 100 μm away from a second surface of the first glass substrate; and
a lens on the second surface of the glass substrate, wherein the lens is a beam expander, and wherein the lens is aligned with the hole;
a fiber protrusion array (FA), wherein the FA comprises:
a second glass substrate; and
a V-groove into a surface of the second glass substrate; and
a glass fiber with a first end and a second end, wherein the first end of the glass fiber is in the hole, and wherein a middle portion of the glass fiber between the first end and the second end is in the V-groove.

18. The apparatus of claim 17, further comprising:
a glass block over the middle portion of the glass fiber.

19. The apparatus of claim 17, wherein the second end of the glass fiber is optically coupled to a photonic integrated circuit (PIC).

20. The apparatus of claim 19, further comprising:
a board, wherein the MLA, the FA, and the PIC are provided on the board.
